(19) United States
(12) Patent Application Publication
(10) Pub. No.: US 2022/0053447 A1
(43) Pub. Date: Feb. 17, 2022

(54) Preserving Emergency Call During Failure to Transfer Subsequent to Registration with the Target Network

(71) Applicant: BlackBerry Limited, Waterloo (CA)

(72) Inventor: Jan Hendrik Lucas Bakker, Fort Worth, TX (US)

(21) Appl. No.: 17/125,592

(22) Filed: Dec. 17, 2020

Related U.S. Application Data
(60) Provisional application No. 63/064,764, filed on Aug. 12, 2020.

(51) Int. Cl. H04W 60/00; H04W 36/14; H04W 4/90

(52) U.S. Cl. CPC H04W 60/005; H04W 4/90; H04W 36/14

(57) ABSTRACT

A method in a user equipment (UE) for transferring an ongoing connection or ongoing session via a first network includes transmitting a first registration request message to a second network of a first public land mobile network (PLMN); transmitting a first connectivity request message to the second network, the first connectivity request message includes an indication that connectivity belongs to the ongoing connection or the ongoing session; receiving, in response to the first connectivity request message, a message comprising a cause code from the second network; transmitting, in response to receiving the message comprising the cause code, a second registration request message to a third network of a second PLMN, the first PLMN and the second PLMN are different; and transmitting a second connectivity request message to the third network, the second connectivity request message includes the indication that the connectivity belongs to the ongoing connection or the ongoing session.

### CROSS-REFERENCE TO RELATED APPLICATIONS

This application claims priority to Provisional Patent Application No. 63/064,764 filed on Aug. 12, 2020. The aforementioned application is hereby incorporated by reference in its entirety.

### BACKGROUND

As used herein, the term “user equipment” (alternatively “UE”) might in some cases refer to mobile devices or wireless devices such as mobile telephones, personal digital assistants, handheld, laptop computers or personal computers, and similar devices that have telecommunications capabilities, including text and email functionality. The terms UE, mobile device, and wireless device may be used interchangeably herein. Such a UE might include a device and its associated removable memory module, such as but not limited to a Universal Integrated Circuit Card (UICC) that includes a Subscriber Identity Module (SIM) application, a Universal Subscriber Identity Module (USIM) application, or a Removable User Identity Module (R-UIM) application. Alternatively, such a UE might include the device itself without such a module. In other cases, the term “UE” might refer to devices that have similar capabilities but that are not transportable, such as desktop computers, set-top boxes, or network appliances. The term “UE” can also refer to any component that can terminate a communication session for a user. Also, the terms “user agent,” “UA,” “user device,” and “mobile device” might be used synonymously herein.

An emergency call or session is a special type of call or session. It usually has a higher priority than other calls in a network, its bearers or flows have different characteristics than those of other calls, e.g., the bearers could have one or more of a higher priority or higher Quality of Service (QoS). Furthermore, the UE may not need a subscription with a network to request an emergency call. For example, an emergency call can be completed if the UICC is absent, or the UE is associated with an expired or invalid subscription, etc. Interrupting or preventing emergency calls can have dire consequences.

Similarly, a revenue bearing call or session is important to the stakeholders (e.g. network operators, service operators, etc.). If it prematurely fails or if re-establishment is needed, revenue may be lost or quality indicators may be negatively impacted. A traditional example of a revenue bearing call or session is a voice call or session.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram of an embodiment of an architecture for interworking between 5GS and EPC/U-TRAN.

FIG. 2 is a message flow diagram of an embodiment of preserving an emergency call during handover from 5GC to EPC.

FIG. 3 is a message flow diagram of an embodiment of preserving an emergency call during handover from EPC to 5GC.

FIG. 4 is a diagram of an embodiment of a network element.

FIG. 5 is a diagram of an embodiment of a communications device.

FIG. 6 is a diagram of an embodiment of a system suitable for implementing one or more embodiments disclosed herein.

### DESCRIPTION

An emergency call may be established by a UE that operates in a single registration mode, i.e., the UE only registers with a single network at any given time (the term registering is considered synonymous for attaching, depending on the context of the use of the term). The network may be a fifth generation (5G) core network supported by an access network or an older network, for example, a typical fourth generation (4G) core network supported by an access network. An example of an access network supporting the 4G core network is evolved universal terrestrial radio access network (E-UTRAN), i.e., an evolved universal terrestrial radio access (E-UTRA) connected to an evolved packet core (EPC). If the emergency call is established in one network (e.g. 5G core network supported by an access network) and there is no interworking between the two networks (e.g. 5G core network supported by an access network and EPC or 4G core network supported by an access network), handover of the emergency call between networks may fail and the emergency call may be dropped. Described herein are several techniques for handing over an emergency call between a 5G core network and an EPC network.

A 5G access network can be at least one of multiple access networks including new radio (NR) and E-UTRA. A 5G access network provides access to the 5G core network (5GC). A wireless local area network (WLAN) can also be used to access the 5GC. A UE uses non-access stratum (NAS) protocols to communicate with a core network via an access network. A typical network element in the EPC for handling of NAS messages, is a mobility management entity (MME). The MME is an EPC network node. A typical network element in the 5GC, for handling of NAS messages, is an access and mobility management function (AMF) or session management function (SMF). The AMF and SMF are 5G core network nodes.

The NAS protocol consists of a mobility management (MM) protocol and a session management (SM) protocol. An example of an EPC NAS MM protocol message is an attach message, e.g. the ATTACH REQUEST message. An example of an EPC NAS SM protocol message is a packet data network (PDN) connection request message, e.g. the PDN CONNECTIVITY REQUEST message. The UE and MME typically terminate EPC NAS SM protocol messages and EPC NAS MM protocol messages. An example of a 5GC NAS mobility protocol message is a registration message, e.g. the REGISTRATION REQUEST message. An example of a 5GC NAS session management protocol message is a protocol data unit (PDU) session request message, e.g. the PDU SESSION ESTABLISHMENT REQUEST message. The UE and SMF typically terminate 5GC NAS SM protocol messages. The UE and AMF typically terminate 5GC NAS MM protocol messages. The sender of the aforementioned NAS messages may receive a response message to any of these NAS messages. For example, the response message to the ATTACH REQUEST message is a NAS response message, e.g., ATTACH REJECT message or ATTACH ACCEPT message, etc. An example of a response message to a REGISTRATION REQUEST message is a REGISTRATION ACCEPT message or a REGISTRATION REJECT message, etc. An example of a response message to a PDN CONNECTIVITY REQUEST message is an ACTIVATE (DEFAULT) EPS BEARER CONTEXT REQUEST message or a PDN CONNECTIVITY REJECT message, etc. An example of a response message to a PDU SESSION ESTABLISHMENT REQUEST message is a PDU SESSION ESTABLISHMENT ACCEPT message or a PDU SESSION ESTABLISHMENT REJECT message, etc.

A UE can be in a mode or mode of operation. In idle mode (generally as opposed to connected mode) the UE cannot initiate NAS procedures involving session management and involving the session management protocol. A NAS procedure of the mobility management and involving the mobility management protocol is needed to change the UE from idle mode to connected mode.

When performing an EPC NAS attach procedure, the UE can request to be attached for only emergency bearer services by means of an attach procedure. Subsequent to a successful request for being attached for only emergency bearer services the UE is known to be “attached for emergency bearer services only”. An attach request message transmitted by the UE to the network during the attach procedure can also include a PDN connection request message (e.g. a PDN CONNECTIVITY REQUEST message).

When performing a 5GC NAS registration procedure, the UE can request to be registered by a registration procedure (which causes a registration message to be transmitted by the UE to the network) or request to be registered for only emergency services by means of the registration procedure. Subsequent to a successful request for being registered for only emergency services the UE is known to be “registered for emergency services only”.

In some communication environments, 4G access networks (i.e. an access network connected to 4G core network EPC) are more prevalent than 5G access networks (i.e. an access network connected to 5G core network (5GC)). A UE may need to transfer existing connections from a 5G access network to a 4G access network (e.g., when handing over from the access network providing access to 5GC), or vice-versa (e.g. when handing over from the access network providing access to EPC). A system, such as evolved packet system (EPS) and 5GS, includes a core network and an access network. A PLMN can operate one or more of these systems, e.g. a PLMN can operate EPS and 5GS. Some PLMNs can share a cell of an access network. Thus, a UE may have to select a cell, the PLMN that offers services via the cell, and the core network (e.g. EPC or 5GC) that the cell connects to.

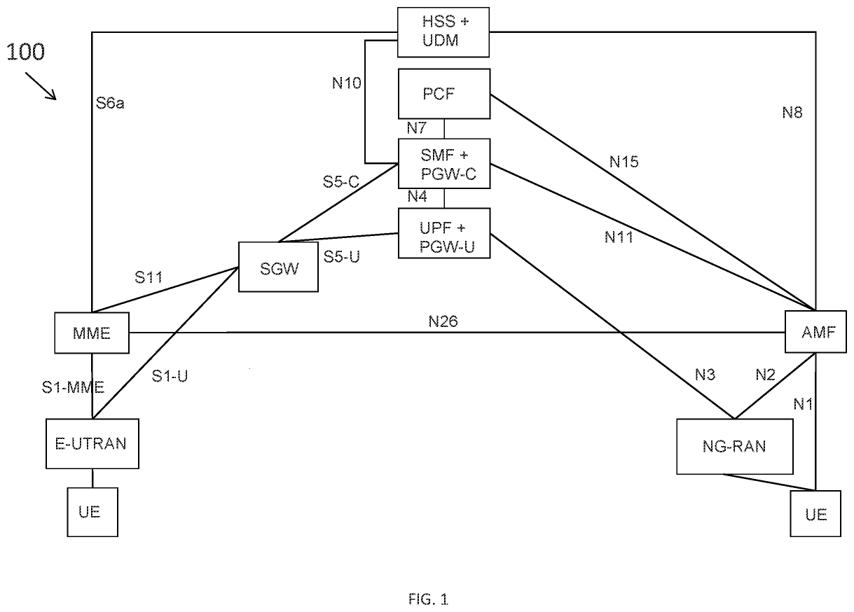

FIG. 1 is a diagram of an embodiment of an architecture 100 for interworking between 5G and EPC. The N26 interface is an inter-core network (CN) interface between the MME and 5G system (5GS) AMF in order to enable interworking between EPC and the 5G core. Support of N26 interface in the network is optional for interworking. A PLMN that operates EPS and 5GS may support N26, for example.

The core PDN gateway (PGW-C)+SMF and user plane function (UPF)+PDN gateway user plane (PGW-U) are dedicated for interworking between 5GS and EPC, which are optional and are based on UE MM Core Network Capability and UE subscription. UEs that are not subject to 5GS and EPC interworking may be served by entities not dedicated for interworking, i.e. either by PGW or SMF/UPF.

There can be another UPF (not shown) between the NG radio access network (NG-RAN) and the UPF+PGW-U, i.e. the UPF+PGW-U can support an N9 interface towards an additional UPF, if needed. Figures and procedures in this specification that depict a serving gateway (SGW) make no assumption whether the SGW is deployed as a monolithic SGW or as a serving gateway (SGW) split into its control-plane and user-plane functionality.

Unless the UE is dual registered (e.g. registered with a 5G network and attached with a 4G network), the UE cannot be in connected mode in 5GS and EPS at the same time. For this reason the N26 interface may be used to provide interworking between the 5GS and EPS to allow for handover between the networks.

An emergency call in limited service state occurs, for example, when the UE does not have sufficient credentials to access the network (e.g. the UE may not need a subscription with a network to request an emergency call). A network can also turn an emergency call into a limited service state emergency call when it hands over the emergency call into a cell the UE is otherwise not allowed to access. When a network turns an emergency call by a UE into an emergency call by limited service state UE, the UE is in connected mode. In limited service state, subscription-based services are not or no longer allowed. Subscription-based services generally include common services such as short message service (SMS), non-emergency-voice calls, access to the internet, etc.

When a UE performs an emergency attach procedure with the EPC (i.e. an attach procedure resulting in the sending of an attach request message for emergency bearer services only), the UE cannot obtain non-emergency services while it is so attached. The UE is in limited service state. When a UE performs an attach procedure with the EPC (also known as a non-emergency attach procedure or a normal attach procedure, i.e. an attach procedure resulting in the sending of an attach request message or attach request message for EPS services only), the UE can also use non-emergency services (assuming the attach request is accepted by the network) (i.e. both emergency and non-emergency services). In either case the sent attach request message can include a PDN connection request for emergency bearer services. The UE can also send a PDN connection request (for emergency bearer services) standalone, i.e., the PDN connection request is not included in an attach request message.

When a UE performs an emergency registration procedure with the 5GC (i.e. a registration procedure resulting in the sending of a registration request message for emergency services only), the UE cannot use non-emergency services while it is so registered. The UE is in limited service state. When a UE performs a registration procedure with the 5GC (also known as a non-emergency registration procedure or a normal registration procedure, i.e. a registration procedure resulting in the sending of a registration request message), the UE can also obtain non-emergency services (assuming the registration request is accepted by the network) (i.e. both emergency and non-emergency services). In either case, the UE can send a PDU session request (e.g., a PDU SESSION ESTABLISHMENT REQUEST message) to establish a PDU session for emergency services separately or subsequent to sending the registration request message or subsequent to the registration request being accepted by the network. NAS messages are transmitted via the access stratum (AS). NAS messages may be concatenated or piggybacked. In particular, a 5GS session management (5GSM) message can be piggybacked in specific 5GS mobility management (5GMM) transport messages (the 5GSM messages can be transmitted in an information element in the 5GMM transport messages). Eventually, the 5GMM message (e.g. REGISTRATION REQUEST message) is received at the AMF and the 5GSM message (e.g. PDU SESSION ESTABLISHMENT REQUEST message) is received at the SMF. In this case, the UE, the AMF, and the SMF execute the 5GMM procedure and the 5GSM procedure in parallel. The success of the 5GMM procedure is not dependent on the success of the piggybacked 5GSM procedure.

There are many reasons why a PDN connection request or PDU session request, sent by a UE, can be rejected by the network. For example, a request can be rejected due to network failures, network overload, misconfiguration, UE subscription limitations or user subscription limitations. Other examples exist.

The 5GS supports interworking with an EPS either via the N26 interface (between AMF and MME) or without an N26 interface (i.e. via coordination between or collocation of packet data gateway (PDG) and SMF or UPF). The problems discussed herein relate to networks that support interworking without N26 and to a UE that operates in single registration mode.

A UE in dual registration mode, but not yet concurrently registered in the other system is also affected by the problems discussed herein.

A UE in dual registration mode and concurrently registered in the other system is affected by a subset of the problems discussed herein.

When registered in the 5GC via a cell of a 5G access network and when having an emergency PDU session, possibly among other, for example, non-emergency PDU sessions, the UE may determine a cell of a 4G access network is or became more desirable. The UE may need to transfer the ongoing connectivity provided by some or all of the PDU sessions to the EPC serving the cell of the 4G access network, for example, while the UE is in IDLE mode with EPC.

In order to transfer the ongoing connectivity provided by the emergency PDU session from the 5GC to the EPC, the UE performs an attach procedure, and preferably includes a PDN CONNECTIVITY REQUEST message representing the connectivity provided by the emergency PDU session in the attach message. However, some UEs may also include a PDN CONNECTIVITY REQUEST message representing the connectivity provided by a non-emergency PDU session in the attach message. In the later case, the UE would have to transfer the connectivity provided by emergency PDU session in a subsequent standalone transmitted PDN CONNECTIVITY REQUEST message. The UE may, subsequent to receiving an acceptance to the attach request, attempt to transfer more (non-emergency) PDU sessions.

In a 4G network, for various reasons the MME or the EPC may not be able to accept the attempt to transfer more (non-emergency) PDU sessions. For example, network congestion or other resource unavailability, etc. In some current approaches, if the attempt to transfer an emergency PDU session is rejected, the ongoing emergency call using the connectivity provided by the emergency PDU session, cannot be transferred to the network. The UE may retry the request to transfer the emergency PDU session to network, e.g. up to five times. While the UE is retrying the user and the emergency responders or emergency personnel operating the public safety answering point (PSAP) may not be able to communicate with each other. Eventually, the ongoing emergency call may undesirably or prematurely terminate. This may leave the user of the UE, whose emergency call was terminated, in danger.

When attached in the EPC via a cell of a 4G access network and when having a PDN connection for emergency bearer services, possibly among other, for example, non-emergency PDN connections, the UE may determine a cell of a 5G access network is or became more desirable. The UE may need to transfer the ongoing connectivity provided by some or all of the PDN connections to the 5GC serving the cell of the 5G access network, for example, while the UE is in IDLE mode with 5GC.

In order to transfer the ongoing connectivity provided by the PDN connection for emergency bearer services from the EPC to the 5GC, the UE performs a registration procedure, and subsequently transmits a PDU session request message representing the connectivity provided by the PDN connection for emergency bearer services. The UE may also attempt to transfer connectivity provided by one or more (non-emergency) PDN connections.

In a 5G network, for various reasons the SMF or the 5GC may not be able to accept the attempt to transfer connectivity provided by one or more PDN connections, for example, network congestion or other resource unavailability, etc. In some current approaches, if the attempt to transfer connectivity provided by an emergency PDN connection is rejected, the ongoing emergency call using the connectivity provided by the PDN connection for emergency bearer services cannot be transferred to the network. The UE may retry the request to transfer the emergency PDN connection to network, e.g. up to five times. While the UE is retrying the user, the emergency responders, or emergency personnel operating the PSAP may not be able to communicate with each other. Eventually, the ongoing emergency call may undesirably or prematurely terminate. This may leave the user of the UE, whose emergency call was terminated, in danger.

The current procedures for transferring ongoing emergency calls from 5G to EPC or from EPC to 5GC insufficiently consider failure scenarios. While solutions exist for handling failure scenarios in case of “fallback” from one system to another system, i.e. prior to establishing an emergency call, solutions have not been considered for preventing unexpected and undesirable termination of an ongoing emergency call during transfer from one system to another system. A further aspect of this problem space is the scenario where the UE desires to transfer connectivity (including emergency connectivity) from 5GC to EPC, yet the UE omits including a PDN connection request for emergency connectivity in the attach request sent to the EPC.

In a first embodiment, when the UE has one or more PDU sessions to transfer from 5GS to EPS, the UE performs an attach procedure and PDN connectivity request procedure (e.g., resulting in an attach request message including a PDN connectivity request message) to transfer an emergency session included in the one or more PDU sessions to a first network including an EPC. The PDN connectivity request message to be transmitted to the first network (i.e., a first PDN CONNECTIVITY REQUEST message) may include a request type set to “handover of emergency bearer services”. When the request type is set to “handover of emergency bearer services” it indicates that the connectivity belongs to an ongoing emergency call. The first network may reject the PDN connectivity request message sent by the UE. Due to the first network rejecting the PDN connectivity request, the UE may receive a PDN connectivity reject message. The first network sends the PDN connectivity reject message and includes an EPS session management (ESM) cause value in the PDN connectivity reject message. When the UE determines or detects that the rejection was received in response to a request message with request type set to “handover of emergency bearer services”, the UE refrains from retrying to send another PDN connectivity request message (or a message substantially similar to the first PDN connectivity request message) to the first network. If the UE determines or detects that the rejection was received in response to a request with request type set to “handover of emergency bearer services”, the UE performs a second attach, i.e. one of an attach for emergency bearer services with a second network or a normal attach with the second network. The second network includes an EPC or a 5GC. If the second network includes an EPC: the performing of the second attach with the second network may further depend on the ESM cause value in the reject message. The second attach comprises sending an attach request by the UE. If the second attach comprises the attach for emergency bearer services (i.e., an emergency attach), the attach request includes a PDN CONNECTIVITY REQUEST message (i.e., a second PDN CONNECTIVITIY REQUEST message) requesting to activate the default bearer corresponding to a default EPS bearer context for the emergency PDU session, and the request type of the PDN CONNECTIVITY REQUEST is set to “handover of emergency bearer services”. When the request type is set to “handover of emergency bearer services” it indicates that the connectivity belongs to the ongoing emergency call. In some cases, the second PDN CONNECTIVITY REQUEST message has substantially the same content as the first PDN CONNECTIVITY REQUEST message. If the second attach comprises the normal attach, the attach request may (but does not need to) include the PDN CONNECTIVITY REQUEST message requesting to activate the default bearer corresponding to a default EPS bearer context for the emergency PDU session. If a PDN CONNECTIVITY REQUEST message with the request type set to “handover of emergency bearer services” (e.g., the first PDN CONNECTIVITY REQUEST message) is not included in the attach request message, that PDN CONNECTIVITY REQUEST message may be sent standalone. The network may accept the PDN CONNECTIVITY REQUEST message.

If the second network includes a 5GC, the PLMN of the first network and the PLMN of the second network can be the same. In this case the MME in the EPC of the first network, which rejected the the second PDN CONNECTIVITY REQUEST, is different from the SMF in the 5GC of the second network. As a consequence, a transfer may succeed even though the PLMN of the first network and the second network are the same. If we consider the previous paragraph, the following modifications apply: the second attach is a second registration, the attach for emergency bearer services is a registration for emergency services, the PDN CONNECTIVITY REQUEST message requesting to activate the default bearer corresponding to a default EPS bearer context for the emergency PDU session is a PDU SESSION CONNECTIVITY REQUEST message requesting to activate the PDU session. The second PDN CONNECTIVITY REQUEST message is a second PDU SESSION CONNECTIVITY REQUEST message. The access network via which the second PDU SESSION CONNECTIVITY REQUEST message is transmitted may be a non-3GPP access network or a wireless local area network (WLAN).

The first and the second network are each part of a public land mobile network (PLMN). The first PLMN operating the first network and the second PLMN operating the second network can be the same PLMN or different PLMNs. The second PLMN can be either the first PLMN or a PLMN considered equivalent to the first PLMN or the second PLMN is neither the first PLMN nor considered equivalent. PLMNs are equivalent when their PLMN identities are present in an equivalent PLMN list. The UE may be configured with the equivalent PLMN list.

A PLMN can comprise for example a 5GC+access network, or an EPC+access network, or a 5GC+access network and an EPC +access network. A PLMN operator operates one or more core networks+access networks.

In some embodiments, performing the attach for emergency bearer services with the second network is subject to the lower layers of the UE or access stratum (AS) layer of the UE indicating to the NAS (or NAS layer of the UE) that the network supports emergency bearer services in limited service state. Alternatively, performing the attach procedure (e.g., a normal attach) with a network including the EPC is subject to the lower layers of the UE or AS layer of the UE having indicated to the NAS (or NAS layer of the UE) that the first network supports emergency bearer services in limited service state.

In some embodiments, the UE performs the attach (e.g., a normal attach) or the attach for emergency bearer services with the second network if the ESM cause value in the PDN CONNECTIVITY REJECT message from the first network matches one or more predefined ESM cause values. The one or more predefined ESM cause values includes, for example, #54 “PDN connection does not exist”. In this case, the second network is different from the first network from which the ESM cause value was received. The first and the second network are each part of a public land mobile network (PLMN). The first PLMN operating the first network and the second PLMN operating the second network can be the same PLMN or different PLMNs. The second PLMN can be either the first PLMN or a PLMN considered equivalent to the first PLMN or the second PLMN is neither the first PLMN nor considered equivalent. PLMNs are equivalent when their PLMN identities are present in an equivalent PLMN list. The UE may be configured with the equivalent PLMN list. The first network (of the first PLMN) may set the ESM cause value to one of the one or more predefined ESM cause values in the response to the first PDN CONNECTIVITY REQUEST.

In some embodiments, in a shared network, a UE can attempt to register to one of multiple PLMNs of the shared network. In the shared network, when the UE receives the PDN CONNECTIVITY REJECT message, the UE performs an attach procedure with another PLMN including an EPC, the another PLMN is one of the multiple PLMNs of the shared network. The another PLMN may be equivalent to the PLMN from which the ESM cause value or the PDN CONNECTIVITY REJECT message was received.

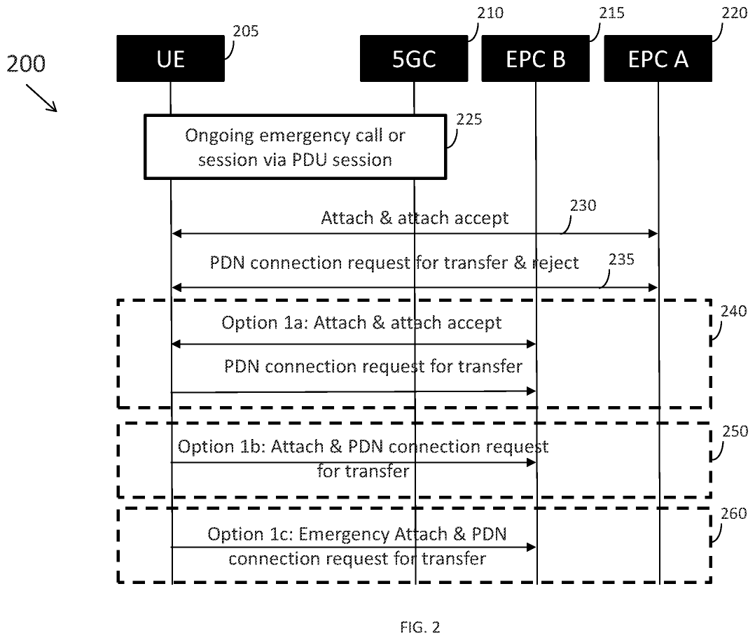

FIG. 2 is a message flow diagram 200 of an embodiment of preserving an emergency call during handover or transfer from 5GC to an EPC. During an ongoing emergency PDU session or call 225 between the UE 205 and a 5GC 210, the UE 205 may determine to handover or transfer to an EPC A 220. At 230, the UE 205 sends an attach request message to the EPC A 220 and receives an attach accept message from the EPC A 220. At 235, the UE 205 sends a PDN CONNECTIVITY REQUEST message to transfer the ongoing emergency PDU session or call 225 to the EPC A 220 and receives a PDN CONNECTIVITY REJECT message from the EPC A 220. In some cases, the PDN CONNECTIVITY REQUEST message may be transmitted with the attach message. In other cases, the PDN CONNECTIVITY REQUEST message may be transmitted separate from the attach message, i.e., the PDN CONNECTIVITY REQUEST message may be a standalone message. In some cases, the PDN CONNECTIVITY REQUEST message may include a request type indicating handover of emergency bearer services. The PDN CONNECTIVITY REJECT message may include a cause value indicating that the PDN connection does not exist.

In a first option 240, in response to receiving the PDN CONNECTIVITY REJECT message, the UE 205 sends an attach message to the EPC B 215 and receives an attach accept message from the EPC B 215. The sending of the attach message to the EPC B 215 may depend on an ESM cause code value received in the PDN CONNECTIVITY REJECT message. Subsequently, the UE 205 sends a PDN CONNECTIVITY REQUEST message to transfer the ongoing emergency PDU session or call 225 to the EPC B 215.

In a second option 250, in response to receiving the PDN CONNECTIVITY REJECT message, the UE 205 sends an attach message including a PDN CONNECTIVITY REQUEST message to transfer the ongoing emergency PDU session or call 225 to the EPC B 215. The sending of the attach message to the EPC B 215 may depend on an ESM cause code value received in the PDN CONNECTIVITY REJECT message.

In a third option 260, in response to receiving the PDN CONNECTIVITY REJECT message, the UE 205 sends an emergency attach message including a PDN CONNECTIVITY REQUEST message to transfer the ongoing emergency PDU session or call 225 to the EPC B 215. In other words, the second option uses a normal attach while the third option uses an emergency attach. The sending of the attach message to the EPC B 215 may depend on an ESM cause code value received in the PDN CONNECTIVITY REJECT message.

The PDN CONNECTIVITY REQUEST messages in options 240, 250 and 260 may be substantially the same.

In some embodiments, when the UE has one or more PDN connections to transfer from EPS to 5GS, the UE performs a first registration procedure with a first network including the 5GC. The UE also performs a PDU session request procedure with request type set to “existing emergency PDU session” to transfer an emergency session included in the one or more PDN connections to the first network including the 5GC. Due to the PDU session request procedure the UE generates a first PDU session request message (e.g., a PDU SESSION ESTABLISHMENT REQUEST message). One or more PDU session request messages may be piggy-backed with a first registration request message to the first network. The first 5GC network may accept the first registration request sent by the UE. The first 5GC network subsequently sends a registration accept message to the UE. Upon receipt of the registration accept message the UE establishes a 5GMM context. After establishing the 5GMM context, the UE can perform or complete the PDU session request procedure to transfer the emergency session. For example, the UE completes the PDU session request procedure when it has piggy-backed the first PDU session request message, and subsequently the 5GMM context is created and the UE receives a response to the first PDU session request message. Upon receipt of a PDU session request message, the first 5GC network may reject, using a PDU session reject message (e.g., a PDU SESSION ESTABLISHMENT REJECT message), the first PDU session request message sent by the UE. The first 5GC network includes a 5GSM cause value in the PDU session reject message. The UE receives the PDU session reject message. When the UE receives the PDU session reject message, the UE refrains from retrying to send another PDU session request message (or a message substantially similar to the first PDU session request message) to the first network. When the UE receives the PDU session reject message, the UE performs one of a registration for emergency services with a second network or a normal registration with a second network using a second registration request message. The second registration request message is either a registration request message for emergency services to the second network or a registration request to the second network. The second network includes 5GC or an EPC. If the second network includes a 5GC and the second network accepts the registration request for emergency services, the second network sends a registration accept message to the UE or if the second network accepts the registration request (for non-emergency services), the second network sends a registration accept message to the UE. When the UE receives the registration accept message, the UE transfers the PDN connection for emergency bearer services by sending a PDU session request message with request type set to “existing emergency PDU session”. In some cases, if the PDU session request message with request type set to “existing emergency PDU session” was piggy-backed with the second registration request message, upon receiving the registration accept message, the UE completes the PDU session request procedure (and effectively completes the transfer of the PDN connection for emergency bearer services). When the UE sends the second registration request message for emergency services or when the UE sends the second registration request message for non-emergency services, the UE includes a Follow-on request indicator set to “Follow-on request pending” in the second registration request. The Follow-on request indicator set to “Follow-on request pending” indicates to the network that the UE should remain in connected mode because a PDU session request procedure is being performed or being contemplated. The first and the second network are each part of a PLMN. The first PLMN operating the first network and the second PLMN operating the second network can be the same PLMN or different PLMNs. The second PLMN can be either the first PLMN or a PLMN considered equivalent to the first PLMN or the second PLMN is neither the first PLMN nor considered equivalent. PLMNs are equivalent when their PLMN identities are present in an equivalent PLMN list. The UE may be configured with the equivalent PLMN list.

If the second network includes an EPC, the PLMN of the first network and the PLMN of the second network can be the same. In this case the SMF in the 5GC of the first network, which rejected the the second PDU SESSION CONNECTIVITY REQUEST message, is different from the MME in the EPC of the second network. As a consequence, a transfer may succeed even though the PLMN of the first network and the second network are the same. If we consider the previous paragraph, the following modifications apply: the second registration is a second attach, the registration for emergency services is an attach for emergency bearer services, etc.

A PLMN can comprise for example a 5GC+access network, or an EPC+access network, or an 5GC+access network and an EPC+access network. A PLMN operator operates one or more core networks+access networks. In a first enhancement of the second embodiment, performing the registration for emergency services with the second network is subject to the lower layers of the UE or AS layer of the UE indicating to the NAS (or NAS layer of the UE) that the network supports emergency bearer services in limited service state. Alternatively, performing registration procedure with a network including the 5GC is subject to the lower layers of the UE or AS layer of the UE having indicated to the NAS (or NAS layer of the UE) that the first network supports emergency bearer services in limited service state, if the one or more PDN connections includes a PDN connection for emergency bearer services.

In some embodiments, the UE performs the registration for emergency services with the second network if the 5GSM cause value matches one or more predefined 5GSM cause values. The one or more predefined 5GSM cause values includes, for example, #54 “PDU session does not exist”. The second network is different from the first network from which the 5GSM cause value was received. The first and the second network are each part of a public land mobile network (PLMN). The first PLMN operating the first network and the second PLMN operating the second network can be the same PLMN or different PLMNs. The second PLMN can be either the first PLMN or a PLMN considered equivalent to the first PLMN or the second PLMN is neither the first PLMN nor considered equivalent. PLMNs are equivalent when their PLMN identities are present in an equivalent PLMN list. The UE may be configured with the equivalent PLMN list. The first network may set the 5GSM cause value to one of the one or more predefined 5GSM cause values in the response to the first PDU SESSION REQUEST. The UE may select the second network from the first PLMN, if the second network belongs to a different system than the system of the first network having transmitted the 5GSM cause value to the UE.

In some embodiments, in a shared network, a UE can attempt to register to one of multiple PLMNs of the shared network. In the shared network, when the UE receives the PDU Session reject message, the UE performs a registration procedure with another PLMN including a 5GC, the another PLMN is one of the multiple PLMNs of the shared network. The another PLMN may be equivalent to the PLMN from which either the 5GSM cause value was received or the PDU Session reject message was received.

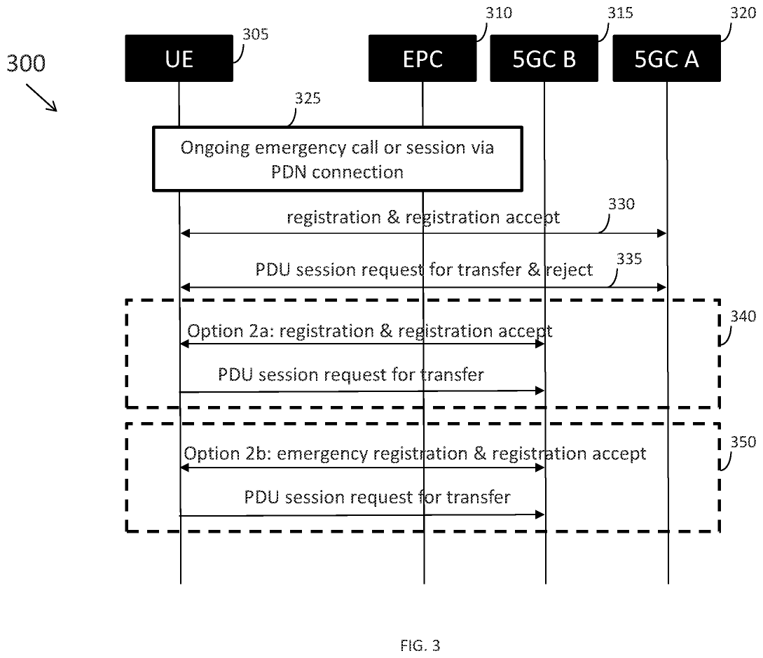

FIG. 3 is a message flow diagram 300 of an embodiment of preserving an emergency call during handover from an EPC network to a 5GC network. During an ongoing emergency PDN connection or call 325 between the UE 305 and a EPC 310, the UE 305 may determine to handover or transfer to 5GC A 320. At 330, the UE 305 sends a registration request message to the 5GC A 320 and receives a registration accept message from the 5GC A 320. At 335, the UE 305 generates and sends a PDU session request message (e.g., a PDU SESSION ESTABLISHMENT REQUEST message) to transfer the ongoing emergency PDN connection or call 325 to the 5GC A 320 and receives a PDU session reject message (e.g., a PDU SESSION ESTABLISHMENT REJECT message) from the 5GC A 320. In some cases, the PDU session request message may be piggy-backed with the registration request message. In other cases, the PDU session request message may be transmitted separate from the registration request message, i.e., the PDU session request message may be a standalone message. In either case, the 5GMM procedure is logically separate from the 5GSM procedure, but the 5GSM procedure cannot complete successfully if the 5GMM procedure does not complete successfully (i.e. a 5GMM context is established in the UE). In some cases, the PDU session request message may indicate an existing emergency PDU session is ongoing. The PDU session reject message may include a cause value indicating that the PDU session does not exist.

In a first option 340, in response to receiving the PDU session reject message, the UE 305 sends a registration request message to the 5GC B 315 and receives a registration accept message from the 5GC B 315. The UE 305 generates a PDU session request message to transfer the ongoing emergency PDN connection or call 325 to the 5GC B 315. The PDU session request message to transfer the ongoing emergency PDN connection or call 325 can for example be piggy-backed or transmitted standalone.

In a second option 350, in response to receiving the PDU session reject message, the UE 305 sends an emergency registration message to the 5GC B 315 and receives a registration accept message from the 5GC B 315. Subsequently, the UE 305 sends a PDU session request message to transfer the ongoing emergency PDU session or call 325 to the 5GC B 315. In other words, the first option uses a normal registration while the second option uses an emergency registration. The PDU session request message to transfer the ongoing emergency PDN connection or call 325 can for example be piggy-backed or transmitted standalone.

The PDU session request messages in options 340 and 350 may be substantially the same.

In some embodiments, preserving an emergency call during handover from a source core network to a target core network comprises verifying, by the UE, whether the target network supports handover of existing emergency sessions. The target core network may comprise one of an EPC or a 5GC. The verifying whether the target network supports handover comprises sending an indication that the UE supports Request Type flag “handover” for PDN connectivity request during the attach procedure, if the target core network is the EPC. The verifying whether the target network supports handover comprises indication that verification performed during the during Registration and Registration Update, if the target core network is the 5GC. If the UE determines the target core network does not support handover, the UE selects another PLMN, the other PLMN being an equivalent PLMN, or the UE attempts transfer of the emergency call to another Internet Protocol-Connectivity Access Network (IP-CAN). An IP-CAN is an access network that provides IP connectivity. Or the UE attempts transfer of the emergency call to the circuit-switched domain.

The following are proposed changes to 3GPP TS 24.301 that may enable the embodiments described herein.

3GPP TS24.301 Section 5.5.1.2.5A “Attach for emergency bearer services not accepted by the network”. Upon receiving the ATTACH REJECT message to an attach request including a PDN CONNECTIVITY REQUEST message with request type set to “handover of emergency bearer services”, the ATTACH REJECT message including EMM cause #19 “ESM failure” and including an ESM cause value in the included PDN CONNECTIVITY REJECT message set to #54 “PDN connection does not exist”, the UE shall attempt to perform a PLMN selection. If:
i) the selected PLMN is an equivalent PLMN or different from the PLMN from which the PDN CONNECTIVITY REJECT message was received, initiate an attach for emergency bearer services to the selected PLMN and include the PDN CONNECTIVITY REQUEST message with request type set to “handover of emergency bearer services”; and
ii) no equivalent PLMN can be selected, inform the upper layers of the failure to establish the emergency bearer.

NOTE 1a: This can result in the upper layers requesting to perform transfer of the established emergency PDU session or emergency bearer context to non-3GPP access (see 3GPP TS 23.402 [11] or 3GPP TS 24.501 [54]), or other implementation specific mechanisms, e.g. procedures specified in 3GPP TS 24.229 [13D] can result in the emergency call being transferred to another IP-CAN.

3GPP TS24.301 Section 5.5.1.2.5B “Attach for initiating a PDN connection for emergency bearer services not accepted by the network”. If the network cannot accept attach request including a PDN CONNECTIVITY REQUEST message with request type set to “handover of emergency bearer services” and with attach type not set to “EPS emergency attach”:
if the received ATTACH REJECT message includes EMM cause value #19 “ESM failure” and includes an ESM cause value in the included PDN CONNECTIVITY REJECT message set to #54 “PDN connection does not exist”, the UE shall attempt to perform a PLMN selection. If:
i) the selected PLMN is an equivalent PLMN or different from the PLMN from which the PDN CONNECTIVITY REJECT message was received, initiate an EPS attach to the selected PLMN and include the PDN CONNECTIVITY REQUEST message with request type set to “handover of emergency bearer services”; and
ii) no equivalent PLMN can be selected, inform the upper layers of the failure to establish the emergency bearer.

NOTE 1a: This can result in the upper layers requesting to perform transfer of the established emergency PDU session or emergency bearer context to non-3GPP access (see 3GPP TS 23.402 [11] or 3GPP TS 24.501 [54]), or other implementation specific mechanisms, e.g. procedures specified in 3GPP TS 24.229 [13D] can result in the emergency call being transferred to another IP-CAN.
otherwise, the UE shall perform the procedures as described in subclause 5.5.1.2.5. Then if the UE is in the same selected PLMN or equivalent PLMN where the last attach request was attempted, the UE shall attempt EPS attach for emergency bearer services including the PDN CONNECTIVITY REQUEST message.

3GPP TS24.301 Section 6.5.1.4 “UE requested PDN connectivity procedure not accepted by the network”. If the PDN CONNECTIVITY REQUEST message was sent with request type set to:
“emergency” in a stand-alone PDN connectivity procedure and the UE receives a PDN CONNECTIVITY REJECT message; or
“handover of emergency bearer services” in a stand-alone PDN connectivity procedure and the UE receives a PDN CONNECTIVITY REJECT message with ESM cause value not set to one of the one or more predefined ESM cause values,
then the UE may:
a) inform the upper layers of the failure to establish the emergency bearer; or

NOTE 2: This can result in the upper layers requesting establishment of a circuit switched (CS) emergency call (if not already attempted in the CS domain) or other implementation specific mechanisms, e.g. procedures specified in 3GPP TS 24.229 [13D] can result in the emergency call being attempted to another IP-CAN.
b) detach locally, if not detached already, attempt EPS attach for emergency bearer services.

If the PDN CONNECTIVITY REQUEST message was sent with request type set to “handover of emergency bearer services” in a stand-alone PDN connectivity procedure or the UE receives a PDN CONNECTIVITY REJECT message with ESM cause value set to one of the one or more predefined ESM cause values, then the UE shall detach locally and attempt to perform a PLMN selection. If:
i) the selected PLMN is an equivalent PLMN and different from the PLMN from which the PDN CONNECTIVITY REJECT message was received, initiate an EPS attach and transmit the PDN CONNECTIVITY REQUEST message with request type set to “handover of emergency bearer services” to the selected PLMN; and
ii) no equivalent PLMN can be selected, inform the upper layers of the failure to establish the emergency bearer.

NOTE 3: This can result in the upper layers requesting to perform transfer of the established emergency PDU session or emergency bearer context to non-3GPP access (see 3GPP TS 23.402 [11] or 3GPP TS 24.501 [54]), or other implementation specific mechanisms, e.g. procedures specified in 3GPP TS 24.229 [13D] can result in the emergency call being transferred to another IP-CAN.

3GPP TS24.301 Annex B.1. Cause #54—PDN connection does not exist.

This ESM cause is used by the network at handover from a non-3GPP access network or from NG-RAN to indicate that the MME does not have any information about the requested PDN connection. ESM cause #54 or ESM cause value #54 is an example cause value of one of the one or more predefined ESM cause values.

The following are proposed changes to 3GPP TS 24.501 that may enable the embodiments described herein.

3GPP TS 24.501 Section 6.4.1.4 “UE requested PDU session establishment procedure not accepted by the network”. If the PDU SESSION ESTABLISHMENT REQUEST message was sent with request type set to:
“initial emergency request” and the UE receives a PDU SESSION ESTABLISHMENT REJECT message; or
“existing emergency PDU session” and the UE receives a PDU SESSION ESTABLISHMENT REJECT message with 5GSM cause value not set to one of the one or more predefined 5GSM cause values,
then the UE may:
a) inform the upper layers of the failure of the procedure; or

NOTE 2: This can result in the upper layers requesting another emergency call attempt using domain selection as specified in 3GPP TS 23.167 [6].
b) de-register locally, if not de-registered already, attempt initial registration for emergency services.

If the PDU SESSION ESTABLISHMENT REQUEST message was sent with request type set to “existing emergency PDU session” or the UE receives a PDU SESSION ESTABLISHMENT REJECT message with 5GSM cause value set to one of the one or more predefined 5GSM cause values, then the UE shall deregister locally and attempt to perform a PLMN selection. If:
i) the selected PLMN is an equivalent PLMN and different from the PLMN from which the PDN CONNECTIVITY REJECT message was received, initiate a registration procedure with the selected PLMN and transmit the PDU SESSION ESTABLISHMENT REQUEST with request type set to “existing emergency PDU session”; and
ii) no equivalent PLMN can be selected, inform the upper layers of the failure of the procedure.

NOTE 3: This can result in the upper layers requesting transfer of an established emergency PDU session or emergency bearer context to non-3GPP access (see 3GPP TS 23.402 [7A] or the present specification) or implementation specific mechanisms, e.g. procedures specified in 3GPP TS 24.229 [14] can result in the emergency call being transferred to another IP-CAN.5GSM cause #54 or 5GSM cause value #54 is an example cause value of one of the one or more predefined ESM cause values.

In the embodiments presented in this disclosure, the UE does not retry the request to transfer the emergency PDN connection with the same network, e.g. up to five times or the UE does not retry the request to transfer the emergency PDU session with the same network, e.g. up to five times. The UE refrains from retrying the request to transfer the connectivity with the same network upon receiving the rejection.

The several embodiments described above may be combined depending upon the networks and/or the UE. Further, certain steps may be omitted from embodiments if not required for handing over an emergency call

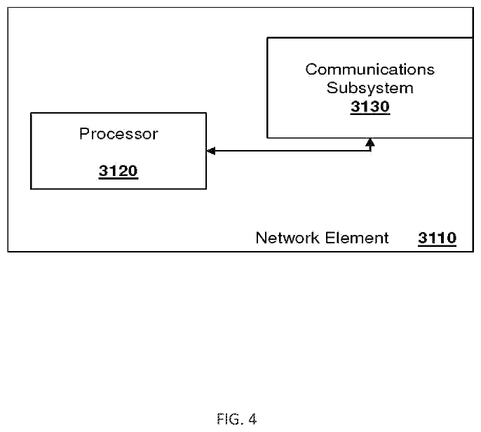

The various methods or operations described herein may be implemented by a network element. An example network element is shown with regard to FIG. 4. In FIG. 4, network element 3110 includes a processor 3120 and a communications subsystem 3130, where the processor 3120 and communications subsystem 3130 cooperate to perform the methods or operations previously described.

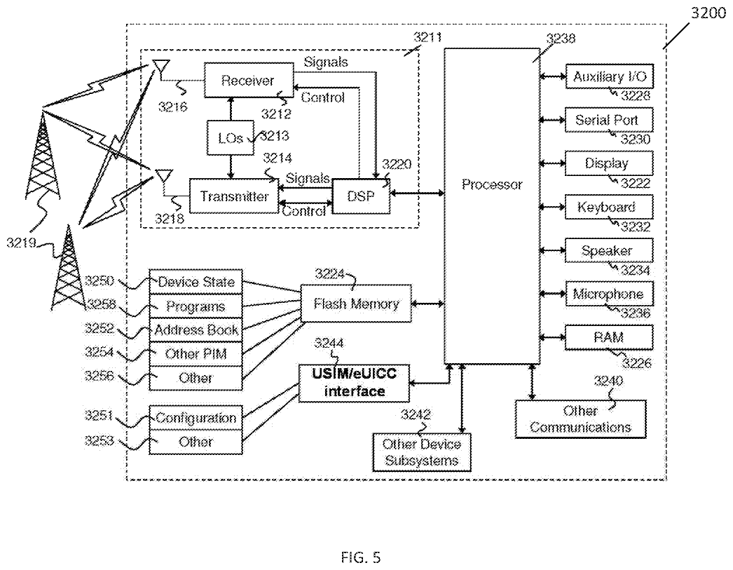

Further, the various methods or operations described herein may be implemented by a communications device (e.g., UEs, network nodes, etc.). An example of a communications device is described below with regard to FIG. 5. The communications device 3200 may comprise a two-way wireless communication device having voice and data communication capabilities. In some embodiments, voice communication capabilities are optional. The communications device 3200 may have the capability to communicate with other computer systems on the Internet. Depending on the exact functionality provided, the communications device 3200 may be referred to as a data messaging device, a two-way pager, a wireless e-mail device, a cellular telephone with data messaging capabilities, a wireless internet appliance, a wireless device, a smart phone, a mobile device, or a data communication device, as examples.

Where the communications device 3200 is enabled for two-way communication, it may incorporate a communication subsystem 3211, including a receiver 3212 and a transmitter 3214, as well as associated components such as one or more antenna elements 3216 and 3218, local oscillators (LOs) 3213, and a processing module such as a digital signal processor (DSP) 3220. The particular design of the communication subsystem 3211 may be dependent upon the communication network 3219 in which the communications device 3200 is intended to operate.

Network access may also vary depending upon the type of communication network 3219. In some networks, network access is associated with a subscriber or user of the communications device 3200. The communications device 3200 may use a USIM or eUICC in order to operate on a network. The USIM/eUICC interface 3244 is typically similar to a card slot into which a USIM/eUICC card may be inserted. The USIM/eUICC card may have memory and may hold many key configurations 3251 and other information 3253, such as identification and subscriber-related information.

When network registration or activation procedures have been completed, the communications device 3200 may send and receive communication signals over the communication network 3219. As illustrated, the communication network 3219 may comprise multiple base stations communicating with the communications device 3200.

Signals received by antenna element 3216 through communication network 3219 are input to receiver 3212, which may perform such common receiver functions such as signal amplification, frequency down conversion, filtering, channel selection, and the like. Analog to digital (A/D) conversion of a received signal allows more complex communication functions, such as demodulation and decoding to be performed in the DSP 3220. In a similar manner, signals to be transmitted are processed, including modulation and encoding for example, by DSP 3220 and are input to transmitter 3214 for digital to analog (D/A) conversion, frequency up conversion, filtering, amplification, and transmission over the communication network 3219 via antenna element 3218. DSP 3220 not only processes communication signals but also provides for receiver and transmitter control. For example, the gains applied to communication signals in receiver 3212 and transmitter 3214 may be adaptively controlled through automatic gain control algorithms implemented in DSP 3220.

The communications device 3200 generally includes a processor 3238 which controls the overall operation of the device. Communication functions, including data and voice communications, are performed through communication subsystem 3211 in cooperation with the processor 3238. Processor 3238 also interacts with further device subsystems such as the display 3222, flash memory 3224, random access memory (RAM) 3226, auxiliary input/output (I/O) subsystems 3228, serial port 3230, one or more user interfaces such as keyboards or keypads 3232, speaker 3234, microphone 3236, one or more other communication subsystems 3240 such as a short-range communications subsystem, and any other device subsystems generally designated as 3242. While the other communication subsystems 3240 and other device subsystems 3242 are depicted as separate components in FIG. 5, it is to be understood that other communication subsystems 3240 and other device subsystems 3242 (or parts thereof) may be integrated as a single component. Serial port 3230 may include a universal serial bus (USB) port or other port currently known or developed in the future.

Some of the illustrated subsystems perform communication-related functions, whereas other subsystems may provide “resident” or on-device functions. Notably, some subsystems, such as keyboard 3232 and display 3222, for example, may be used for both communication-related functions, such as entering a text message for transmission over a communication network, and device-resident functions, such as a calculator or task list.

Operating system software used by the processor 3238 may be stored in a persistent store such as flash memory 3224, which may instead be a read-only memory (ROM) or similar storage element (not shown). The operating system, specific device applications, or parts thereof, may be temporarily loaded into a volatile memory such as RAM 3226. Received communication signals may also be stored in RAM 3226.

As shown, flash memory 3224 may be constituted by different areas for both computer programs 3258 and program data storage 3250, 3252, 3254, and 3256. These different storage types indicate that each program may allocate a portion of flash memory 3224 for their own data storage use. Processor 3238, in addition to its operating system functions, may enable execution of software applications on the communications device 3200. A predetermined set of applications that control basic operations, including at least data and voice communication applications for example, may typically be installed on the communications device 3200 during manufacturing. Other applications may be installed subsequently or dynamically.

Applications and software may be stored on any computer-readable storage medium. The computer-readable storage medium may be tangible or in a transitory/non-transitory medium such as optical (e.g., CD, DVD, etc.), magnetic (e.g., tape), or other memory currently known or developed in the future.

Software applications may be loaded onto the communications device 3200 through the communication network 3219, an auxiliary I/O subsystem 3228, serial port 3230, other short-range communications subsystem(s) 3240, or any other suitable device subsystem(s) 3242, and installed by a user in the RAM 3226 or a non-volatile store (not shown) for execution by the processor 3238. Such flexibility in application installation may increase the functionality of the communications device 3200 and may provide enhanced on-device functions, communication-related functions, or both. For example, secure communication applications may enable electronic commerce functions and other such financial transactions to be performed using the communications device 3200.

In a data communication mode, a received signal such as a text message or web page download may be processed by the communication subsystem 3211 and input to the processor 3238, which may further process the received signal for output to the display 3222, or alternatively to an auxiliary I/O device 3228.

For voice communications, overall operation of the communications device 3200 is similar, except that received signals may typically be output to a speaker 3234 and signals for transmission may be generated by a microphone 3236. Alternative voice or audio I/O subsystems, such as a voice message recording subsystem, may also be implemented on the communications device 3200. Although voice or audio signal output may be accomplished primarily through the speaker 3234, display 3222 may also be used to provide an indication of the identity of a calling party, the duration of a voice call, or other voice call-related information, for example.

Serial port 3230 may be implemented in a personal digital assistant (PDA)-type device for which synchronization with a user's desktop computer (not shown) may be desirable, but such a port is an optional device component. Such a serial port 3230 may enable a user to set preferences through an external device or software application and may extend the capabilities of the communications device 3200 by providing for information or software downloads to the communications device 3200 other than through a wireless communication network 3219. The alternate download path may, for example, be used to load an encryption key onto the communications device 3200 through a direct and thus reliable and trusted connection to thereby enable secure device communication. Serial port 3230 may further be used to connect the device to a computer to act as a modem.

Other communications subsystems 3240, such as a short-range communications subsystem, are further optional components which may provide for communication between the communications device 3200 and different systems or devices, which need not necessarily be similar devices. For example, one or more other communications subsystems 3240 may include an infrared device and associated circuits and components or a Bluetooth™ communication module to provide for communication with similarly enabled systems and devices. Other communications subsystems 3240 may further include non-cellular communications such as WI-FI, WiMAX, near field communication (NFC), BLUETOOTH, ProSe (Proximity Services) (e.g., sidelink, PC5, D2D, etc.), and/or radio frequency identification (RFID). The other communications subsystem(s) 3240 and/or other device subsystem(s) 3242 may also be used to communicate with auxiliary devices such as tablet displays, keyboards, or projectors.

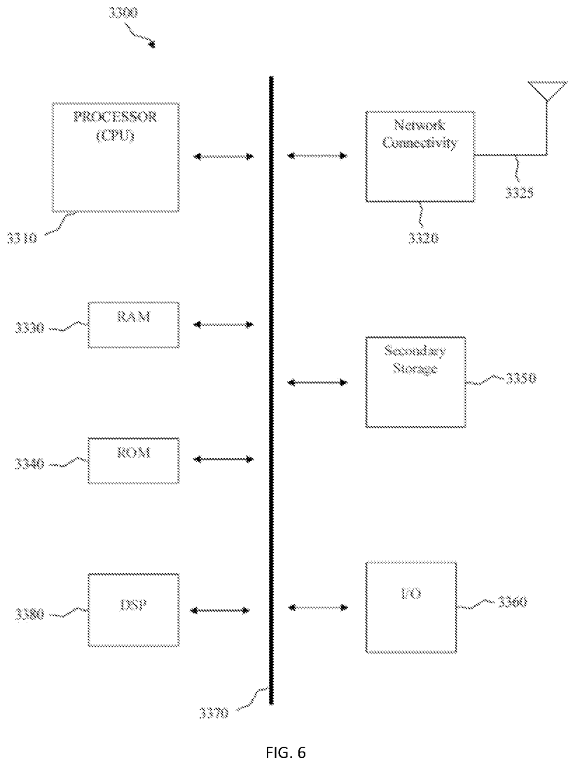

The communications device 3200 and other components described above might include a processing component that is capable of executing instructions related to the actions described above. FIG. 6 illustrates an example of a system 3300 that includes a processing component 3310 suitable for implementing one or more embodiments disclosed herein. In addition to the processor 3310 (which may be referred to as a central processor unit or CPU), the system 3300 might include network connectivity devices 3320, random access memory (RAM) 3330, read only memory (ROM) 3340, secondary storage 3350, and input/output (I/O) devices 3360. These components might communicate with one another via a bus 3370. In some cases, some of these components may not be present or may be combined in various combinations with one another or with other components not shown. These components might be located in a single physical entity or in more than one physical entity. Any actions described herein as being taken by the processor 3310 might be taken by the processor 3310 alone or by the processor 3310 in conjunction with one or more components shown or not shown in the drawing, such as a digital signal processor (DSP) 3380. Although the DSP 3380 is shown as a separate component, the DSP 3380 might be incorporated into the processor 3310.

The processor 3310 executes instructions, codes, computer programs, or scripts that it might access from the network connectivity devices 3320, RAM 3330, ROM 3340, or secondary storage 3350 (which might include various disk-based systems such as hard disk, floppy disk, or optical disk). While only one CPU 3310 is shown, multiple processors may be present. Thus, while instructions may be discussed as being executed by a processor, the instructions may be executed simultaneously, serially, or otherwise by one or multiple processors. The processor 3310 may be implemented as one or more CPU chips.

The network connectivity devices 3320 may take the form of modems, modem banks, ethernet devices, universal serial bus (USB) interface devices, serial interfaces, token ring devices, wireless local area network (WLAN) devices, radio transceiver devices such as code division multiple access (CDMA) devices, Global System for Mobile communication (GSM) radio transceiver devices, universal mobile telecommunications system (UMTS) radio transceiver devices, LTE radio transceiver devices, new generation radio transceiver devices, worldwide interoperability for microwave access (WiMAX) devices, and/or other well-known devices for connecting to networks. These network connectivity devices 3320 may enable the processor 3310 to communicate with the internet or one or more telecommunications networks or other networks from which the processor 3310 might receive information or to which the processor 3310 might output information. The network connectivity devices 3320 might also include one or more transceiver components 3325 capable of transmitting and/or receiving data wirelessly.

The RAM 3330 might be used to store volatile data and perhaps to store instructions that are executed by the processor 3310. The ROM 3340 is a non-volatile memory device that typically has a smaller memory capacity than the memory capacity of the secondary storage 3350. ROM 3340 might be used to store instructions and perhaps data that are read during execution of the instructions. Access to both RAM 3330 and ROM 3340 is typically faster than to secondary storage 3350. The secondary storage 3350 is typically comprised of one or more disk drives or tape drives and might be used for non-volatile storage of data or as an over-flow data storage device if RAM 3330 is not large enough to hold all working data. Secondary storage 3350 may be used to store programs that are loaded into RAM 3330 when such programs are selected for execution.

The I/O devices 3360 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver component 3325 might be considered to be a component of the I/O devices 3360 instead of or in addition to being a component of the network connectivity devices 3320.

The following are incorporated herein by reference for all purposes: 3GPP TS 24.301, and 3GPP TS 24.501.

Described herein is a method in a user equipment (UE) for transferring an ongoing connection or ongoing session via a first network. The method comprises transmitting a first registration request message to a second network of a first public land mobile network (PLMN); transmitting a first connectivity request message to the second network, wherein the first connectivity request message includes an indication that connectivity belongs to the ongoing connection or the ongoing session; receiving, in response to the first connectivity request message, a message comprising a cause code from the second network; transmitting, in response to receiving the message comprising the cause code, a second registration request message to a third network of a second PLMN, wherein the first PLMN and the second PLMN are different; and transmitting a second connectivity request message to the third network, wherein the second connectivity request message includes the indication that the connectivity belongs to the ongoing connection or the ongoing session.

The cause code may contain a session management cause value. The session management cause value may be one of one or more predefined values and transmitting the second registration request message is in response to the UE detecting the session management cause value is set to the one of the one or more predefined values. The indication that the connectivity belongs to the ongoing connection or the ongoing session may comprise an indication that the connectivity belongs to an ongoing emergency call or ongoing emergency session. The first connectivity request message may be a stand-alone message, and the second connectivity request message may be a stand-alone message. The first network may comprise a 5G core network (5GC) and the second network may comprise an evolved packet core (EPC), or the first network may comprise an EPC and the second network may comprise a 5GC. The method may further include that, the UE, in response to the message comprising the cause code, refrains from transmitting another connectivity request message to the second network, wherein the another connectivity request message includes the indication that the connectivity belongs to the ongoing connection or the ongoing session. The method may further include that in response to the UE detecting the session management cause value is set to the one of the one or more predefined values, the UE refrains from transmitting another connectivity request message to the second network, wherein the another connectivity request message includes the indication that the connectivity belongs to the ongoing connection or the ongoing session.

Described herein is a user equipment (UE) for transferring an ongoing connection or ongoing session via a first network. The UE comprises a memory storing instructions; and a processor in communication with the memory and configured to execute the instructions to cause the UE to transmit a first registration request message to a second network of a first public land mobile network (PLMN); transmit a first connectivity request message to the second network, wherein the first connectivity request message includes an indication that connectivity belongs to the ongoing connection or the ongoing session; receive, in response to the first connectivity request message, a message comprising a cause code from the second network; transmit, in response to receiving the message comprising the cause code, a second registration request message to a third network of a second PLMN, wherein the first PLMN and the second PLMN are different; and transmit a second connectivity request message to the third network, wherein the second connectivity request message includes the indication that the connectivity belongs to the ongoing connection or the ongoing session.

The cause code may contain a session management cause value. The session management cause value may be one of one or more predefined values and transmitting the second registration request message is in response to the UE detecting the session management cause value is set to the one of the one or more predefined values. The indication that the connectivity belongs to the ongoing connection or the ongoing session may comprise an indication that the connectivity belongs to an ongoing emergency call or ongoing emergency session. The first connectivity request message may be a stand-alone message, and the second connectivity request message may be a stand-alone message. The first network may comprise a 5G core network (5GC) and the second network may comprise an evolved packet core (EPC), or wherein the first network comprises an EPC and the second network comprises a 5GC. The instructions may further cause the UE to, in response to the message comprising the cause code, refrain from transmitting another connectivity request message to the second network, wherein the another connectivity request message includes the indication that the connectivity belongs to the ongoing connection or the ongoing session. The instructions may further cause the UE to, in response to the UE detecting the session management cause value is set to the one of the one or more predefined values, refrain from transmitting another connectivity request message to the second network, wherein the another connectivity request message includes the indication that the connectivity belongs to the ongoing connection or the ongoing session.

Described herein is a non-transitory computer readable medium comprising instructions which, when executed by a processor of a user equipment (UE), cause the UE to transmit a first registration request message to a second network of a first public land mobile network (PLMN); transmit a first connectivity request message to the second network, wherein the first connectivity request message includes an indication that connectivity belongs to an ongoing connection or an ongoing session; receive, in response to the first connectivity request message, a message comprising a cause code from the second network; transmit, in response to receiving the message comprising the cause code, a second registration request message to a third network of a second PLMN, wherein the first PLMN and the second PLMN are different; and transmit a second connectivity request message to the third network, wherein the second connectivity request message includes the indication that the connectivity belongs to the ongoing connection or the ongoing session.

The cause code may contain a session management cause value. The session management cause value may be one of one or more predefined values and transmitting the second registration request message is in response to the UE detecting the session management cause value is set to the one of the one or more predefined values. The indication that the connectivity belongs to the ongoing connection or the ongoing session may comprise an indication that the connectivity belongs to an ongoing emergency call or ongoing emergency session. The first connectivity request message may be a stand-alone message, and the second connectivity request message may be a stand-alone message. The first network may comprise a 5G core network (5GC) and the second network may comprise an evolved packet core (EPC), or wherein the first network comprises an EPC and the second network comprises a 5GC. The instructions may further cause the UE to, in response to the message comprising the cause code, refrain from transmitting another connectivity request message to the second network, wherein the another connectivity request message includes the indication that the connectivity belongs to the ongoing connection or the ongoing session. The instructions may further cause the UE to, in response to the UE detecting the session management cause value is set to the one of the one or more predefined values, refrain from transmitting another connectivity request message to the second network, wherein the another connectivity request message includes the indication that the connectivity belongs to the ongoing connection or the ongoing session.

While several embodiments have been provided in the present disclosure, it should be understood that the disclosed systems and methods may be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method in a user equipment (UE) for transferring an ongoing connection or ongoing session via a first network, the method comprising:
transmitting a first registration request message to a second network of a first public land mobile network (PLMN);
transmitting a first connectivity request message to the second network, wherein the first connectivity request message includes an indication that connectivity belongs to the ongoing connection or the ongoing session;
receiving, in response to the first connectivity request message, a message comprising a cause code from the second network;
transmitting, in response to receiving the message comprising the cause code, a second registration request message to a third network of a second PLMN, wherein the first PLMN and the second PLMN are different; and
transmitting a second connectivity request message to the third network, wherein the second connectivity request message includes the indication that the connectivity belongs to the ongoing connection or the ongoing session.

2. The method of claim 1, wherein the cause code contains a session management cause value.

3. The method of claim 2, wherein the session management cause value is one of one or more predefined values and transmitting the second registration request message is in response to the UE detecting the session management cause value is set to the one of the one or more predefined values.

4. The method of claim 1, wherein the indication that the connectivity belongs to the ongoing connection or the ongoing session comprises an indication that the connectivity belongs to an ongoing emergency call or ongoing emergency session.

5. The method of claim 1, wherein the first connectivity request message is a stand-alone message, and the second connectivity request message is a stand-alone message.

6. The method of claim 1, wherein the first network comprises a 5G core network (5GC) and the second network comprises an evolved packet core (EPC), or wherein the first network comprises an EPC and the second network comprises a 5GC.

7. The method of claim 1, wherein the UE, in response to the message comprising the cause code, refrains from transmitting another connectivity request message to the second network, wherein the another connectivity request message includes the indication that the connectivity belongs to the ongoing connection or the ongoing session.

8. The method of claim 3, wherein in response to the UE detecting the session management cause value is set to the one of the one or more predefined values, the UE refrains from transmitting another connectivity request message to the second network, wherein the another connectivity request message includes the indication that the connectivity belongs to the ongoing connection or the ongoing session.

9. A user equipment (UE) for transferring an ongoing connection or ongoing session via a first network, the UE comprising:
a memory storing instructions; and
a processor in communication with the memory and configured to execute the instructions to cause the UE to:
transmit a first registration request message to a second network of a first public land mobile network (PLMN);
transmit a first connectivity request message to the second network, wherein the first connectivity request message includes an indication that connectivity belongs to the ongoing connection or the ongoing session;
receive, in response to the first connectivity request message, a message comprising a cause code from the second network;
transmit, in response to receiving the message comprising the cause code, a second registration request message to a third network of a second PLMN, wherein the first PLMN and the second PLMN are different; and
transmit a second connectivity request message to the third network, wherein the second connectivity request message includes the indication that the connectivity belongs to the ongoing connection or the ongoing session.

10. The UE of claim 9, wherein the cause code contains a session management cause value.

11. The UE of claim 10, wherein the session management cause value is one of one or more predefined values and transmitting the second registration request message is in response to the UE detecting the session management cause value is set to the one of the one or more predefined values.

12. The UE of claim 9, wherein the indication that the connectivity belongs to the ongoing connection or the ongoing session comprises an indication that the connectivity belongs to an ongoing emergency call or ongoing emergency session.

13. The UE of claim 9, wherein the first connectivity request message is a stand-alone message, and the second connectivity request message is a stand-alone message.

14. The UE of claim 9, wherein the first network comprises a 5G core network (5GC) and the second network comprises an evolved packet core (EPC), or wherein the first network comprises an EPC and the second network comprises a 5GC.

15. The UE of claim 9, wherein the instructions further cause the UE to, in response to the message comprising the cause code, refrain from transmitting another connectivity request message to the second network, wherein the another connectivity request message includes the indication that the connectivity belongs to the ongoing connection or the ongoing session.

16. The UE of claim 11, wherein the instructions further cause the UE to, in response to the UE detecting the session management cause value is set to the one of the one or more predefined values, refrain from transmitting another connectivity request message to the second network, wherein the another connectivity request message includes the indication that the connectivity belongs to the ongoing connection or the ongoing session.

17. A non-transitory computer readable medium comprising instructions which, when executed by a processor of a user equipment (UE), cause the UE to:
transmit a first registration request message to a second network of a first public land mobile network (PLMN);
transmit a first connectivity request message to the second network, wherein the first connectivity request message includes an indication that connectivity belongs to an ongoing connection or an ongoing session;
receive, in response to the first connectivity request message, a message comprising a cause code from the second network;
transmit, in response to receiving the message comprising the cause code, a second registration request message to a third network of a second PLMN, wherein the first PLMN and the second PLMN are different; and
transmit a second connectivity request message to the third network, wherein the second connectivity request message includes the indication that the connectivity belongs to the ongoing connection or the ongoing session.

18. The non-transitory computer readable medium of claim 17, wherein the cause code contains a session management cause value.

19. The non-transitory computer readable medium of claim 18, wherein the session management cause value is one of one or more predefined values and transmitting the second registration request message is in response to the UE detecting the session management cause value is set to the one of the one or more predefined values.

20. The non-transitory computer readable medium of claim 17, wherein the indication that the connectivity belongs to the ongoing connection or the ongoing session comprises an indication that the connectivity belongs to an ongoing emergency call or ongoing emergency session.
